(19) United States
(12) Patent Application Publication
(10) Pub. No.: US 2014/0056658 A1
(43) Pub. Date: Feb. 27, 2014

(54) CUTTING TOOL WITH REMOVABLE HEAD

(71) Applicants: Kazuo MAEDA, Itami-shi (JP); Hideo MORI, Itami-shi (JP); Naoki KOUMOTO, Itami-shi (JP); Yasuhiro KAJIWARA, Itami-shi (JP)

(72) Inventors: Kazuo MAEDA, Itami-shi (JP); Hideo MORI, Itami-shi (JP); Naoki KOUMOTO, Itami-shi (JP); Yasuhiro KAJIWARA, Itami-shi (JP)

(73) Assignee: Sumitomo Electric Hardmetal Corp., Itami-shi (JP)

(21) Appl. No.: 13/594,180

(22) Filed: Aug. 24, 2012

(51) Int. Cl. B23C 5/10

(52) U.S. Cl. CPC B23C 5/109
USPC 407/40

(57) ABSTRACT

A cutting head having a tapered shaft portion, a helical flute, and a flat shoulder surface is fastened to a shank having a front end surface, a tapered hole, and a helical flute through a fastening attachment in the form of a helical coil. The fastening attachment has a sectional shape substantially analogous in shape to a space defined between the helical flutes. The fastening attachment is fitted in one of the helical flutes, and is threaded into the other of the helical flutes until the shoulder surface is brought into close contact with the front end surface of the shank, and the outer peripheral surface of the tapered shaft portion is brought into close contact with the inner surface of the tapered hole, thus fastening the cutting head to the shank.

### TECHNICAL FIELD

This invention relates to a cutting tool including a cutting head with cutting edges and shank, and further including an improved coupling by means of which the cutting head can be detachably fastened to the shank.

### BACKGROUND OF THE INVENTION

Conventional cutting tools of this type are disclosed e.g. in the below-identified Patent documents:
JP Patent Publication 2001-500801A
JP Patent Publication 2001-505137A
JP Patent Publication 2008-6508A
JP Patent 4117131B

The cutting tool disclosed in Patent document 1 (which is a ball end mill) includes an end mill head, a shank, and a pull rod which is in threaded engagement with both the end mill head and the shank. The end mill head and the shank have abutment surfaces, respectively, which are substantially perpendicular to the axis of the tool. The end mill head and the shank are fastened together by pulling them toward each other with the pull rod until their abutment surfaces abut each other.

The cutting tool of Patent document 2 (which is a milling tool) includes a cutting head, a shank, and a retention means. The retention means, which is inserted in a tapered hole formed in the distal end of the shank, is threaded into the shank, while kept in engagement with the cutting head due to the action of the tapered angle of the tapered hole, thereby pulling the cutting head into the tapered hole until the cutting head is engaged in the tapered hole and thus fastened to the shank.

The cutting tool disclosed in Patent document 3, which includes an interchangeable cutting blade portion, is substantially of the same structure as the milling tool disclosed in Patent document 2. A fixing member, which is in engagement with the cutting blade portion, is inserted into an inserting hole formed in the distal end of the tool body and threaded into the tool body, thereby pulling the cutting blade portion toward the tool body until an abutment surface of the cutting blade portion is fitted on a tapered surface at the distal end of the tool body. The cutting blade portion is thus fastened to the tool body.

The cutting tool disclosed in Patent document 4 includes a male member which corresponds to the cutting head and which is formed with a male thread for fastening, and a female member which corresponds to the shank and which is formed with a female thread (threaded hole). The male member is fastened to the female member by threading its male thread into the threaded hole of the female member. The male thread has no incomplete thread portion to reduce the length of the tool coupling and ensure strength. Thus, when the male member is completely fastened to the female member, a shoulder surface (i.e. an axial end surface) of the male member abuts the distal end of the female member, and at the same time, the root of the male thread of the male member is fitted on a tapered surface at the inlet portion of the threaded hole of the female member.

### BRIEF SUMMARY OF THE INVENTION

In the cutting tool of Patent document 1, since the end mill head is pulled into the shank by operating the pull rod from its rear end, it is difficult to mount and dismount the end mill head. It is impossible to change the end mill head with a new one with the shank mounted on a processing machine. This further makes it difficult to mount and dismount the end mill head.

What is known as the three-way restriction arrangement is used to restrict the end mill head of this cutting tool, which is the combination of threaded engagement between the pull rod and the shank, fitting of the end mill head in the tapered hole of the shank, and abutment between the axial end surfaces (abutment surfaces) of the end mill head and the shank. Thus, in order to control run-out of the cutting edge of such a cutting tool with high precision, its component parts have to be manufactured with high accuracy, which inevitably reduces productivity and increases the cost.

Since it is extremely difficult to form male and female threads such that they are closely in contact with each other over the entire areas thereof, portions tend to develop between such male and female threads where they are incompletely in contact with each other (see gaps g in FIGS. 14 and 15) due to unavoidable manufacturing errors. Such incomplete contact portions make it difficult to accurately and reliably fasten the end mill head to the shank. FIG. 14 shows a conventional fastening arrangement using the threaded engagement only. FIG. 15 shows a conventional fastening arrangement which is the combination of the threaded engagement and taper fitting.

The cutting tools of Patent documents 2 and 3 also have the same problems as the tool of Patent document 1. Further, since the engaging protrusion formed on the retention means (blade fixing member) is brought into engagement with the cutting head (blade) using the action of the tapered surface, the contact surface area of the engaged portions are necessarily small, which makes it difficult to reliably fasten and retain the cutting head during high-load cutting.

The cutting tool of Patent document 4 has a problem that due to the small fitting area between the male and female members of the tool coupling, it is difficult to reliably prevent loosening of the connection. Also, since the taper fitting area between the male and female members is extremely small, this tool is especially inferior in its ability to bear loads perpendicular to the tool axis. This makes it difficult to perform cutting with high accuracy under high loads because the male member tends to move.

An object of this invention is to provide a cutting tool of which the cutting head can be easily mounted and dismounted, which is easy to use, which requires no high manufacturing accuracy, and of which the cutting head can be rigidly and reliably fastened to the shank.

In order to achieve the above object, the present invention provides a cutting tool comprising

a detachable cutting head, a shank, and a fastening attachment in a form of an elastic helical coil,

wherein the cutting head includes a tapered shaft portion, a helical flute formed on an outer periphery of the tapered shaft portion, and a flat shoulder surface provided in the rear and extending radially outwardly from a root of the tapered shaft portion,

wherein the shank includes a front end surface configured to be brought into abutment with the shoulder surface, a tapered hole which is open to the front end surface, the tapered shaft portion being configured to be fitted in the tapered hole, and a helical flute formed on an inner surface of the tapered hole so as to correspond to the helical flute formed on the outer periphery of the tapered shaft portion,

wherein the fastening attachment has a sectional shape substantially analogous to the sectional shape of a space defined between the helical flute formed on the outer periphery of the tapered shaft portion and the helical flute formed on the inner surface of the tapered hole, and

wherein the cutting head is configured to be fastened to the shank by fitting the fastening attachment in either one of the helical flute formed on the outer periphery of the tapered shaft portion and the helical flute formed on the inner surface of the tapered hole, and by inserting the tapered shaft portion into the tapered hole until the fastening attachment is engaged in both the helical flute formed on the outer periphery of the tapered shaft portion and the helical flute formed on the inner surface of the tapered hole and elastically pressed against the surfaces of both helical flutes, with the shoulder surface in close contact with the front end surface of the shank, and an outer peripheral surface portion of the tapered shaft portion in close contact with an inner surface portion of the tapered hole.

The helical flutes formed on the outer periphery of the tapered shaft portion and on the inner surface of the tapered hole are arranged with pitches which are larger than the widths of the respective helical flutes so that the tapered shaft portion and the tapered hole have a tapered outer peripheral surface and a tapered inner surface, respectively, which can be fitted together.

The cutting tool according to the present invention preferably has at least one of the below features:

(1) The fastening attachment is in the form of a tapered helical coil having, in a free state, a winding pitch smaller than pitches with which the respective helical flutes are arranged, whereby the fastening attachment can be stretched and fitted in either one of the helical flute formed on the outer periphery of the tapered shaft portion and the helical flute formed on the inner surface of the tapered hole.
(2) The fastening attachment is structured such that with the fastening attachment stretched until the winding pitch thereof is equal to the pitches with which the respective helical flutes are arranged, the fastening attachment has a tapered angle substantially equal to tapered angles of the tapered shaft portion and the tapered hole, respectively.
(3) The fastening attachment has a substantially parallelogrammic section with one diagonally opposite pair of corners of the parallelogram located radially outwardly and inwardly of the helical coil.
(4) The fastening attachment is made of a material softer than a material forming cutting edges, preferably made of steel.
(5) The contact surface area between the outer peripheral surface of the tapered shaft portion and the inner surface of the tapered hole is 75% or over of the contact surface area if there were no helical flutes.
(6) The helical flute formed on the outer periphery of the tapered shaft portion and the helical flute formed on the inner surface of the tapered hole have helix angles, respectively, which are both 75° and over and less than 90°.

According to the cutting tool of the present invention, the fastening attachment, which is in the form of a helical coil, is fitted in one of the helical flute formed on the outer periphery of the tapered shaft portion and the helical flute formed on the inner surface of the tapered hole, and the tapered shaft portion of the cutting head is threaded into the shank using the fastening attachment as a thread, until the shoulder surface of the cutting head is brought into close contact with the front end surface of the shank and the outer peripheral surface of the tapered shaft portion of the cutting head is brought into close contact with the inner surface of the tapered hole.

With this arrangement, high manufacturing accuracy is required only for the tapered shaft portion, and the fitting surfaces of the tapered shaft portion and the tapered hole (i.e. the outer peripheral surface of the tapered shaft portion and the inner surface of the tapered hole). Thus, run-out of the cutting edges of the cutting tool according to the present invention can be controlled with high accuracy while maintaining high productivity and a low production cost.

The cutting head can be radially positioned (centered) by the fitting portions between the tapered shaft portion and the tapered hole, which have a large surface area. Further, the cutting head is axially positioned, and the thus axially positioned state is maintained, by the abutment between the shoulder surface of the cutting head and the front end surface of the shank. The cutting head is thus reliably held in position, which improves cutting accuracy.

Since the tapered shaft portion of the cutting head is threaded into the tapered hole of the shaft using the fastening attachment as a thread, the cutting head can be easily mounted to and dismounted from the shank, even with the shank mounted on a machine.

Since the fastening attachment is a spring, an element having elasticity, by setting the winding pitch of the coil in a free state smaller than the pitches of the helical flutes, and fitting the fastening attachment in one of the helical flutes by stretching the fastening attachment, the fastening attachment can be elastically pressed against the surface of the helical flute in which the fastening attachment is fitted.

When the fastening attachment is threaded into the other helical flute, the fastening attachment is pressed against the surface of the other helical flute too. This reliably prevents loosening of the fastened condition (prevents the cutting head from turning in the loosening direction). The cutting head is thus securely fastened to the shank.

Operations and advantages of the above-listed preferred arrangements are described later.

### BRIEF DESCRIPTION OF THE DRAWINGS

FIG. 1 is a side view of a cutting tool according to the present invention.

FIG. 2 is a side view of the cutting tool of FIG. 1 with its parts disassembled.

FIG. 3 is an enlarged side view of a tapered shaft portion of a cutting head of the cutting tool shown in FIG. 1.

FIG. 4 is an enlarged sectional view of a tapered hole formed in a shank of the cutting tool shown in FIG. 1.

FIG. 5 is a sectional view of a fastening attachment used in the cutting tool of FIG. 1, in its free state.

FIG. 6 is an enlarged sectional view of a portion of the cutting tool of FIG. 1 where the cutting head is fastened to the shank.

FIG. 7 is an enlarged partial sectional view of the portion where the cutting head is fastened to the shank.

FIG. 8 shows helical flutes having different sections.

FIG. 9 shows data regarding vibrations during cutting, obtained in a performance evaluation test.

FIG. 10 shows data regarding vibrations during cutting for Sample 2 of the invention, obtained in the performance evaluation test.

FIG. 11 shows data regarding vibrations during cutting for Samples 1 and 2 of the invention, obtained in the performance evaluation test.

FIG. 12 shows measurement results for roughness values of surfaces cut by Samples 1 and 2 of the invention.

FIG. 13 shows measurement results of cutting accuracy in the performance evaluation test.

FIG. 14 shows, in an exaggerated manner, an ordinary thread engagement portion.

FIG. 15 shows, in an exaggerated manner, a fastened portion which utilizes both taper fitting and thread engagement.

### DETAILED DESCRIPTION OF THE INVENTION

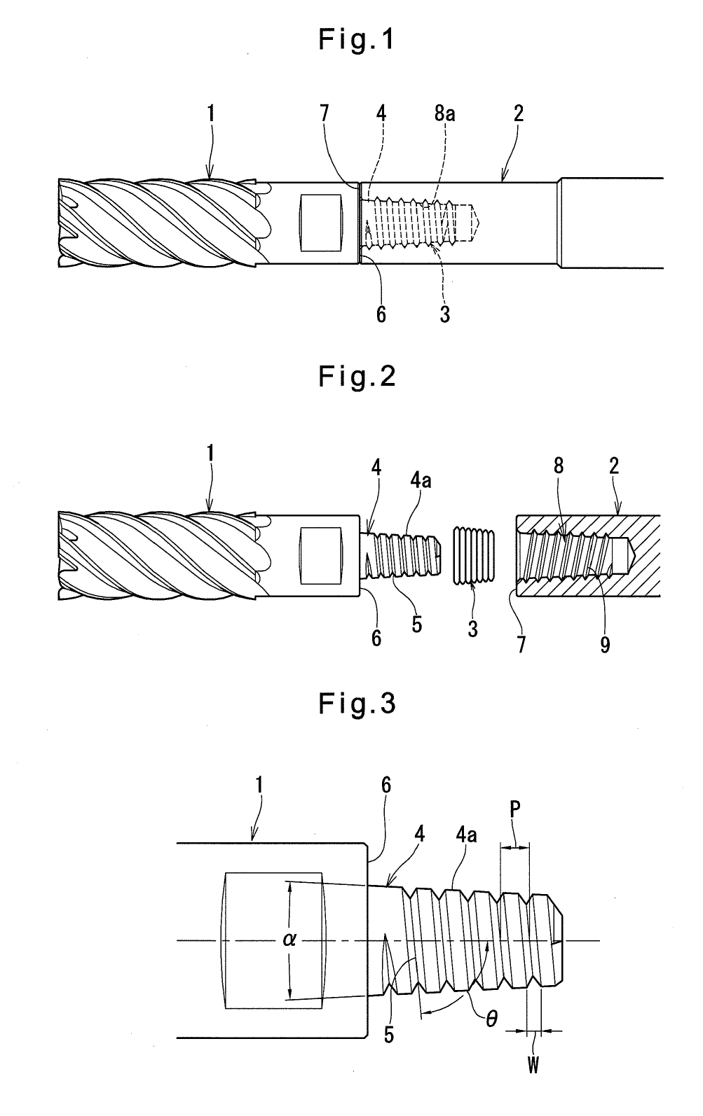

Now the cutting tool with a detachable head embodying the present invention is described with reference to FIGS. 1 to 8.

The cutting tool shown is a square end mill and includes a cutting head 1 having a peripheral cutting edge, an end cutting edge, a chip pocket, a gash, etc., a shank 2 to which the cutting head 1 is fastened, and a fastening attachment 3 that helps to securely fasten the cutting head 1 to the shank 2 and keep the cutting head fastened to the shank 2.

The cutting head 1 includes a tapered shaft portion 4 whose diameter decreases toward its distal end and which is formed with a helical flute 5 on its outer periphery. The cutting head 1 is further formed with a flat shoulder surface 6 extending radially outwardly from the proximal end of the tapered shaft portion 4.

The helical flute 5 has a helix angle θ shown in FIG. 3 and is arranged with a pitch P larger than the width W of the helical flute 5, thereby defining a tapered outer peripheral surface 4a on the outer periphery of the tapered shaft portion 4.

The shank 2 has a front end surface 7 configured to be brought into abutment with the shoulder surface 6 of the cutting head, and a tapered hole 8 formed with a helical flute 9 on its inner periphery, corresponding to the helical flute 5 on the outer periphery of the tapered shaft portion 4. The tapered hole 8 is open to the front end surface 7 so that the tapered shaft portion 4 of the cutting head is inserted into the tapered hole 8.

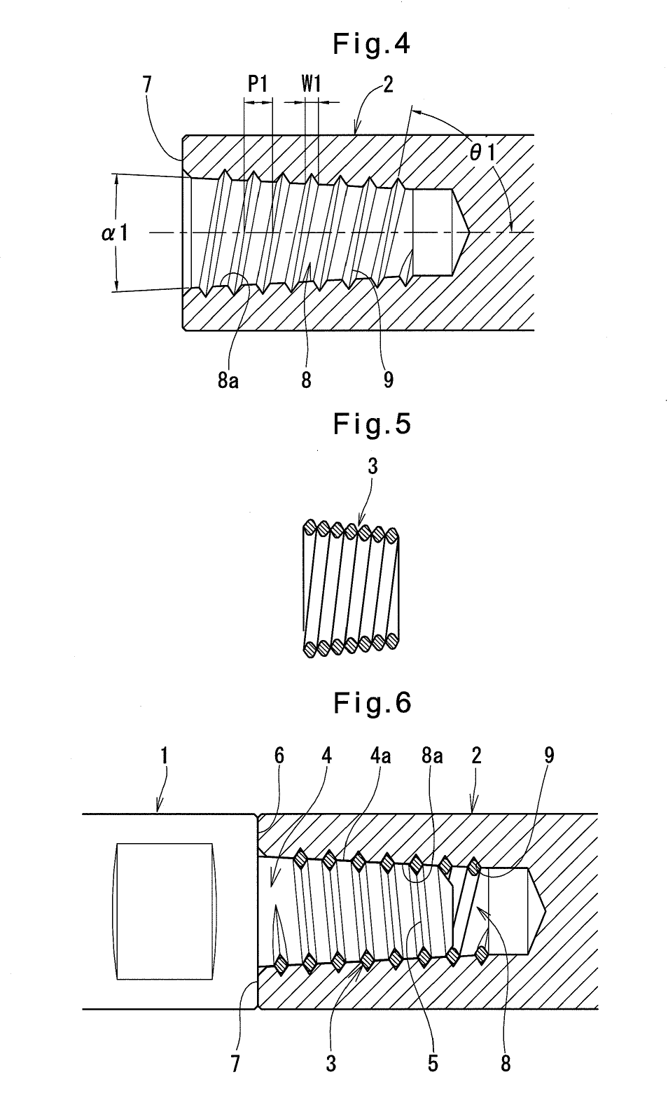

The tapered shaft portion 4, shown in FIG. 3, has a tapered angle α equal to the tapered angle α1 of the tapered hole 8, shown in FIG. 4 so that the tapered shaft portion 4 is snugly received in the tapered hole 8.

The width W1, helix angle θ1 and pitch P1, of the helical flute 9 shown in FIG. 4 are equal to the width W, helix angle θ and pitch P, of the helical flute 5, respectively. Thus, a tapered inner surface 8a is defined on the tapered hole 8.

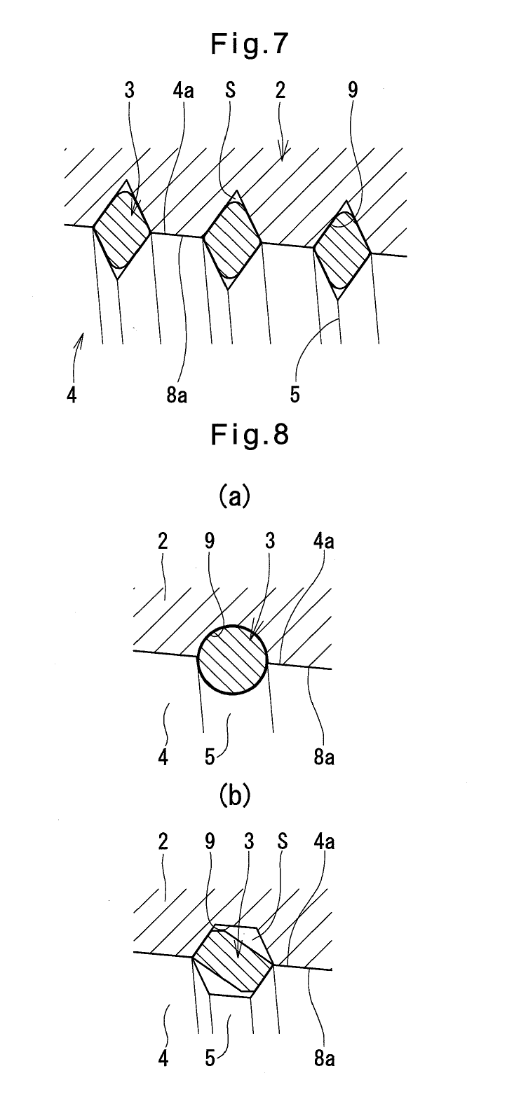

The fastening attachment 3 has a sectional shape substantially analogous to the sectional shape of a space S (see FIG. 7) defined between the helical flute 5 formed on the outer periphery of the tapered shaft portion 4 and the helical flute 9 formed on the inner periphery of the tapered hole 8 (see FIG. 7). The fastening attachment 3 is formed from e.g. a spring steel wire and has elasticity. The attachment 3 is a tapered helical coil member of which the winding pitch is smaller, while not being stressed, than the pitches with which the helical flutes 5 and 9 are arranged.

The fastening attachment 3 of the cutting tool shown is expanded until it is engaged in one of the helical flute 5 formed on the outer periphery of the tapered shaft portion 4 and the helical flute 9 formed on the inner surface of the tapered hole 8. The following description is made on the assumption that the attachment is engaged in the helical flute 9.

With the small-diameter end portion of the fastening attachment 3 engaged in the helical flute 9 on the inner surface of the tapered hole 8, when the fastening attachment 3 is inserted, while rotating it, into the tapered hole 8 (or fitted, while rotating it, onto the helical flute 5), the fastening attachment 3 is expanded under the thrust force generated between the attachment 3 and the surface of the helical flute 9 until the attachment 3 is engaged in the helical flute 9 over substantially the entire area of the flute 9.

In this state (with the attachment fitted in position), the fastening attachment 3 is pressed against the surface of the helical flute under the elastic restoring force of the attachment 3.

Then, the tapered shaft portion 4 of the cutting head 1 is driven into the tapered hole 8 of the shank 2 using the fastening attachment 3 as a thread formed on the tapered hole 8. While the tapered shaft portion 4 is being driven into the tapered hole 8, a thrust force is generated due to relative rotation between the tapered shaft portion 4 and the tapered hole 8 with the helical flute 5 kept in contact with the fastening attachment 3. The thrust force pulls the tapered shaft portion 4 into the tapered hole 8 such that when the tapered shaft portion 4 is fully driven into the tapered hole 8, the fastening attachment 3 is elastically pressed against the surface of the helical flute 5, too.

In this state, the cutting head 1 is completely and securely fastened to the shank 2, with the outer peripheral surface 4a of the tapered shaft portion 4 kept in close contact with the inner surface 8a of the tapered hole 8 and also with the shoulder surface 6 of the cutting head kept in close contact with the front end surface 7 of the shank.

To achieve the object of the invention, the helical flutes 5 and 9 may be semicircular flutes as shown in FIG. 8(a), or trapezoidal flutes as shown in FIG. 8(b). But they are preferably triangular flutes because triangular flutes can be more easily formed. Such triangular helical flutes 5 and 9 define a parallelogrammic space S therebetween. In this case, a fastening attachment 3 having a substantially parallelogrammic section analogous in shape to the parallelogrammic space S is used. With this arrangement, it is possible to ensure a large contact area between the surfaces of the helical flutes 5 and 9 and the fastening attachment 3, and thus to effectively prevent loosening of the fastened condition.

For higher cutting performance and durability, and taking economic and other factors into consideration, the cutting edges of the cutting head 1 may be made of a hard material such as cemented carbide, cBN, single crystal diamond or polycrystalline diamond, with the other portions of the cutting head made of steel or cemented carbide.

The shank 2 is preferably made of steel or cemented carbide because these materials are inexpensive and can be easily formed into the shank.

The fastening attachment 3 is made of a material softer than the material forming the cutting edges, and is preferably made of spring steel. A fastening attachment made of spring steel is radially compressed if fitted in the helical flute 9, and radially expanded if fitted in the helical flute 5, so that the fastening attachment is strongly tightened against the helical flute.

The helix angles θ and θ1 of the respective helical flutes 5 and 9 are preferably 75° or over and less than 90°, and are more preferably as close to 90° as possible for higher axial tightening force and thereby to prevent loosening of the fastened condition. By setting the helix angles within the above range, mounting and dismounting of the cutting head 1 can be carried out within a reasonably short period of time.

For increased radial restriction of the tapered shaft portion 4, the contact surface area between the tapered shaft portion 4 and the tapered hole 8 (i.e. between the outer periphery of the tapered shaft portion and the inner surface of the tapered hole) is preferably as large as possible within such a range that the helical flutes 5 and 9 and the fastening attachment 3 are sufficiently large in size.

Preferably, the above-mentioned contact surface area is 75% or over of the contact surface area between the outer periphery of the tapered shaft portion 4 and the inner surface of the tapered hole 8 if there were no helical flutes 5 and 9.

It is considered suitable that the tapered angles α and α1 of the tapered shaft portion 4 and the tapered hole 8, respectively, be about 5 to 10°, but these angles are not limited to the above range and may be set to any values taking into consideration the force necessary to drive the tapered shaft portion 4 into the tapered hole 8, the depth by which the tapered shaft portion is driven into the tapered hole, and the radial restriction force generated between the contact surfaces of the tapered shaft portion and the tapered hole.

The shoulder surface 6 of the cutting head and the front end surface 7 of the shank may extend perpendicular to the axis of the tool so that these surfaces can be easily formed. But instead, they may be tapered such that they can be fit together.

Two end mills having the structure shown in FIG. 1 were prepared. Their specifications are as follows: tool diameter: 25 mm; total length: 250 mm; distance from the distal end to the shoulder surface 6, of the cutting head 1: 72 mm; root diameter of the tapered shaft portion 4: 13 mm; length of the tapered shaft portion 4: 21 mm; tapered angle α of the tapered shaft portion 4: 7°; helix angle θ of the helical flute 5: 85.8° to 84.8°; pitch P of the helical flute 5: 3 mm; dimensions of the fastening attachment 3 at its large-diameter end while not stressed: 14.63 mm in outer diameter and 11.5 mm in inner diameter; number of cutting edges: 6; material of the cutting edges: cemented carbide; and material of the body of the cutting head: die steel (SKD).

One of the two end mills included a shank made of steel (Sample 1 of the Invention), and the other included a shank made of cemented carbide (Sample 2 of the Invention).

Using Samples 1 and 2 of the Invention and two end mills for comparison purposes, workpieces were cut on a machining center whose specs are defined under BT40 under the following conditions. Vibrations during cutting and accuracy of cutting (roughness and perpendicularity of the finished surface) were compared among the above four end mills. One of the two end mills for comparison purposes was an end mill made of high-speed steel, having a diameter of 26 mm, and including four cutting edges (Comparative Sample 1), and the other was an end mill having four exchangeable cutting blades (Comparative Sample 2).

### Cutting Conditions:

### Workpieces: S50C

Mode of cutting: Down cutting and dry cutting
Cutting velocity Vc: 50 m/minute
Feed/cutting edge fz: 0.03 mm/cutting edge and 0.05 mm/cutting edge
Axial depth of cut ap: 10 mm and 38 mm
Radial depth of cut ae: 0.1 mm and 0.5 mm
Length of the portion of the tool protruding from the gauge line of the spindle arbor OH: Samples 1 and 2 of the Invention=130 mm, Comparative Sample 1=60 mm; and Comparative Sample 2=35 mm

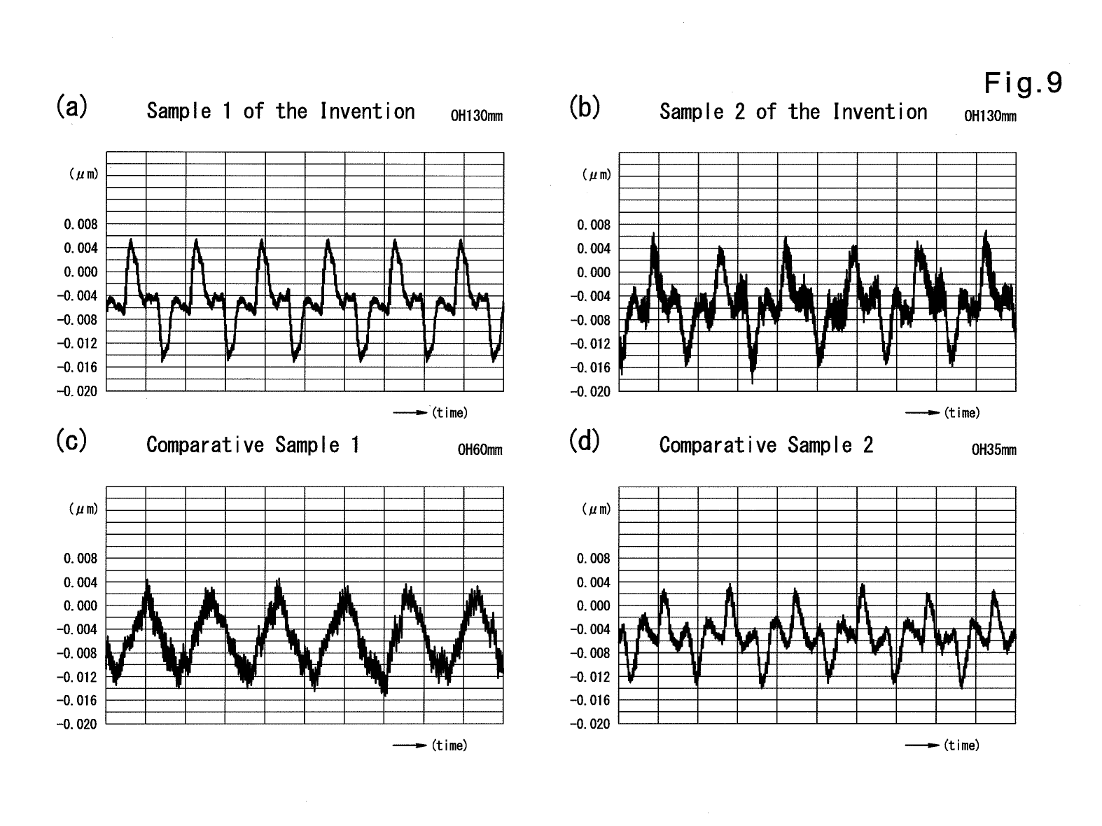

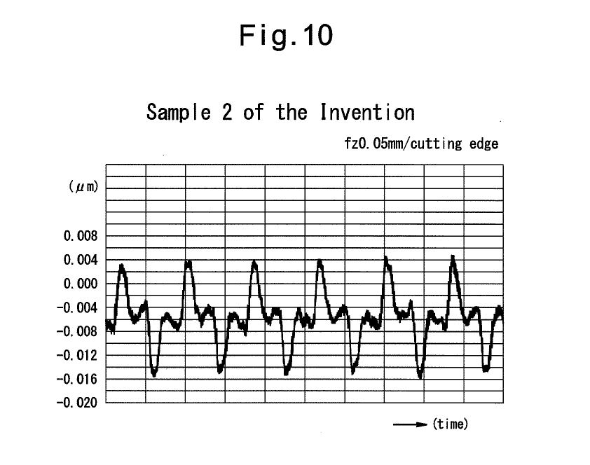

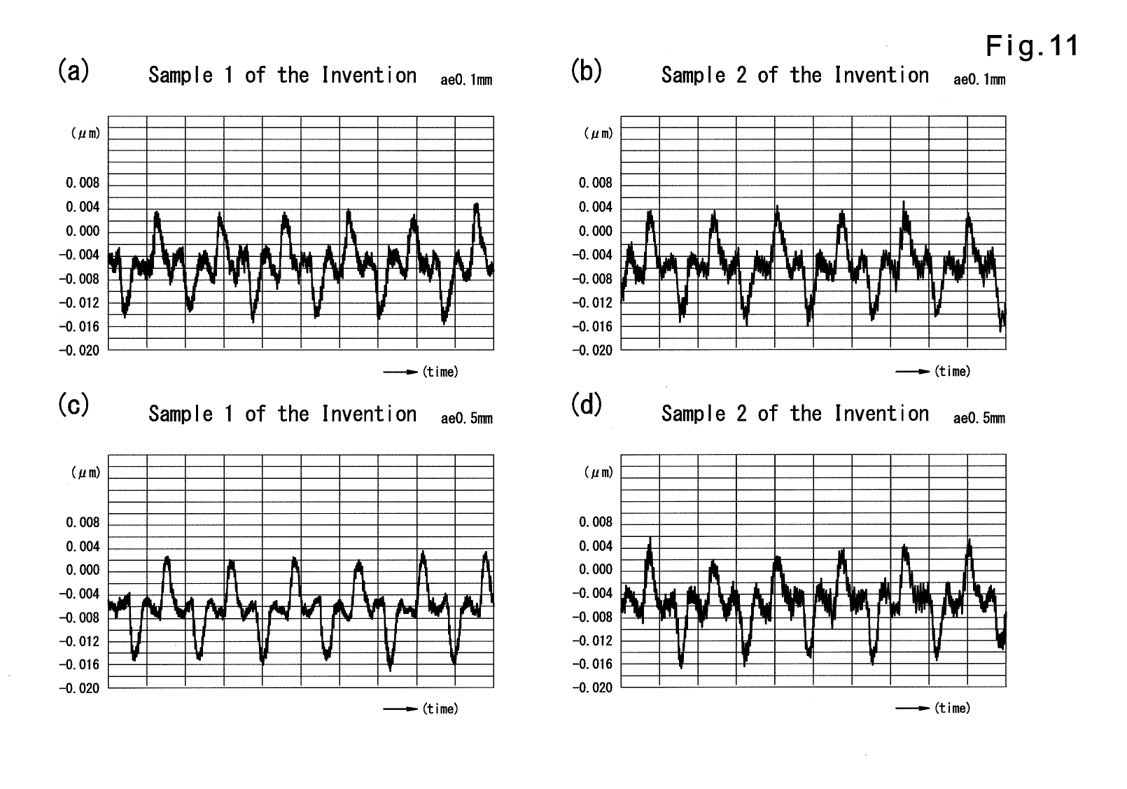

FIGS. 9 to 11 show the measurement results of vibration during cutting in the above performance evaluation test. FIG. 9 shows vibrations measured with Vc at 50 m/minute, fz at 0.03 mm/cutting edge, ap at 10 mm, and ae at 0.1 mm. FIG. 10 shows vibrations measured for Sample 2 of the Invention with fz at 0.05 mm/cutting edge (other conditions are the same as those of FIG. 9). FIG. 11 shows vibrations measured for Samples 1 and 2 of the Invention with Vc at 50 m/minute, fz at 0.03 mm/cutting edge, ap at 38 mm, and ae at 0.1 mm and 0.5 mm.

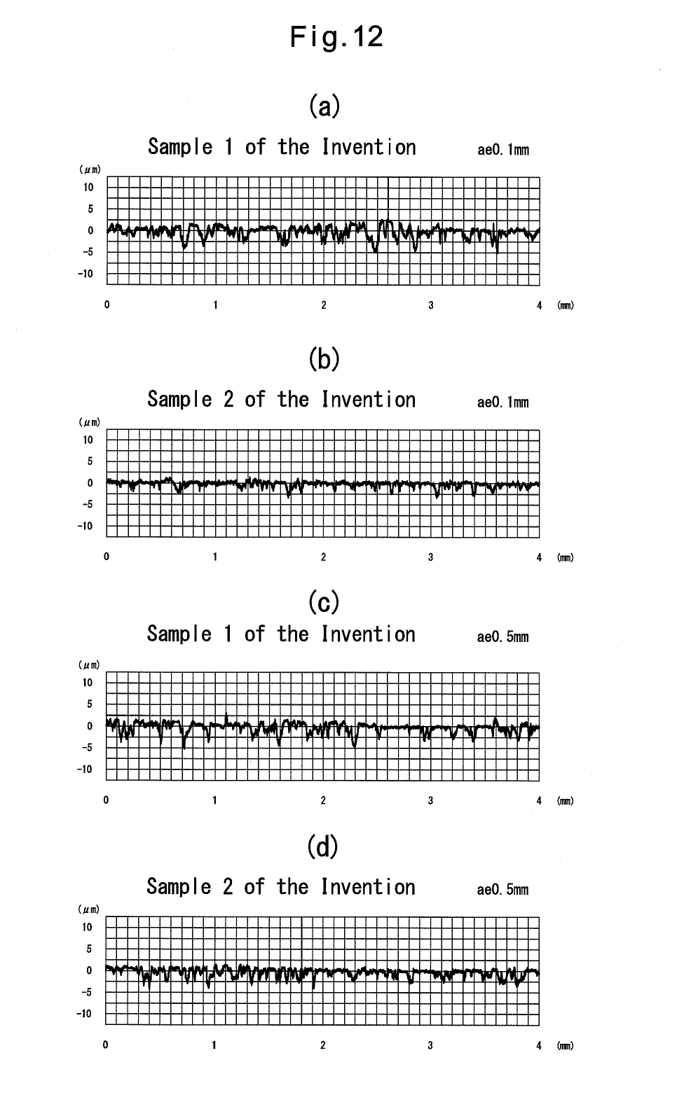

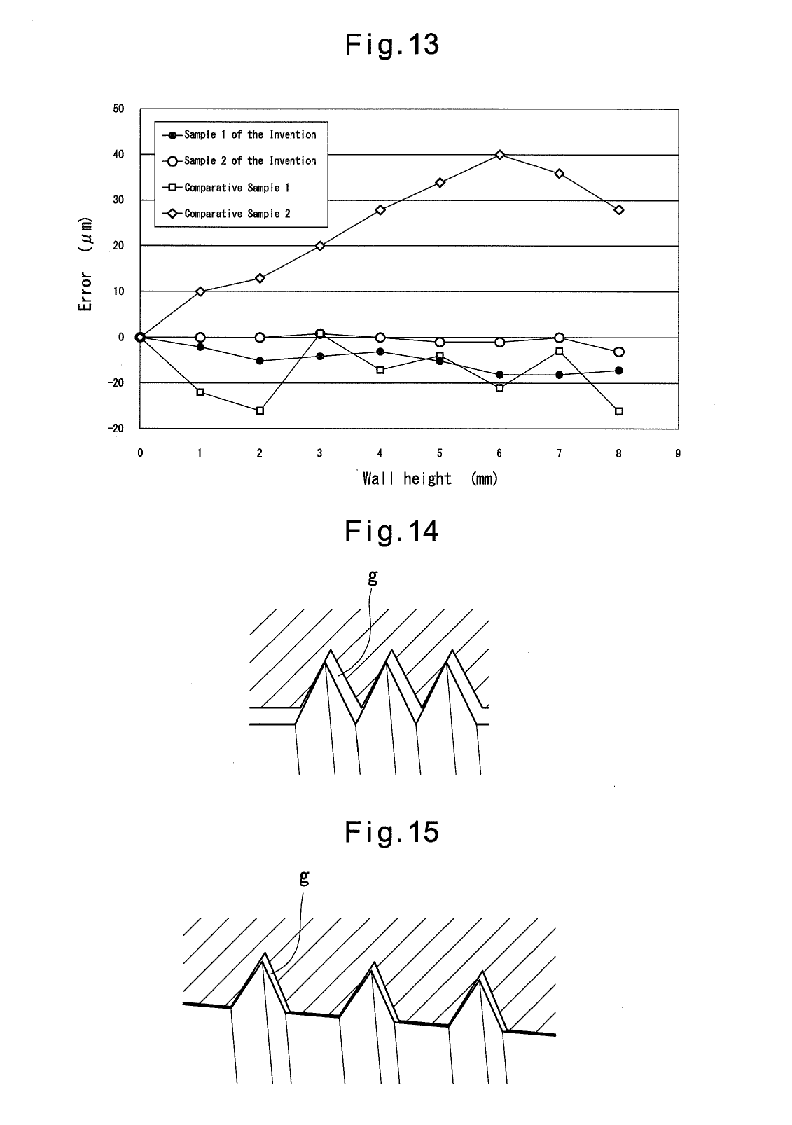

FIG. 12 shows the measurement results of the roughness of the finished surface for Samples 1 and 2 of the Invention. FIG. 13 shows the perpendicularity of the finished surface measured for Samples of the Invention and Comparative Samples with Vc at 50 m/minute, fz at 0.03 mm/cutting edge, ap at 10 mm, and ae at 0.1 mm.

During the test, the cutting heads of Samples of the Invention never came off. While marks due to chattering developed on the surface cut by Sample 1 of the Invention, as is apparent from FIG. 9, vibrations during cutting with Samples 1 and 2 of the Invention were substantially no different from vibrations produced by Comparative Samples 1 and 2, in spite of the fact that Samples of the invention carried a greater number of cutting edges and the lengths of their protruding portions were larger than those of Comparative Samples 1 and 2.

As is apparent from FIG. 13, the maximum error in perpendicularity of the finished surface formed by Comparative Sample 1 was higher than 15 μm. The maximum error in perpendicularity of the finished surface formed by Comparative Sample 2 was as high as 40 μm. In contrast, the maximum errors were less than 10 μm for both Samples 1 and 2 of the Invention. (In fact, the maximum error was near zero for Sample 2 of the Invention). FIG. 13 thus clearly indicates that Samples of the Invention can provide far more accurate finished surfaces than Comparative Samples. This in turn indicates that the cutting head of either of Samples of the Invention is securely and stably fastened to the shank.

This invention is applicable not only to end mills but to e.g. drills, reamers and milling tools.

1. A cutting tool comprising
a detachable cutting head, a shank, and a fastening attachment comprising an elastic helical coil,
wherein the cutting head includes a tapered shaft portion, a helical flute formed on an outer periphery of the tapered shaft portion, and a flat shoulder surface provided in the rear and extending radially outwardly from a root of the tapered shaft portion,
wherein the shank includes a front end surface configured to be brought into abutment with the shoulder surface, a tapered hole which is open to the front end surface, the tapered shaft portion being configured to be fitted in the tapered hole, and a helical flute formed on an inner surface of the tapered hole so as to correspond to the helical flute formed on the outer periphery of the tapered shaft portion,
wherein the fastening attachment has a sectional shape substantially analogous to the sectional shape of a space defined between the helical flute formed on the outer periphery of the tapered shaft portion and the helical flute formed on the inner surface of the tapered hole, and
wherein the cutting head is configured to be fastened to the shank by fitting the fastening attachment in either one of the helical flute formed on the outer periphery of the tapered shaft portion and the helical flute formed on the inner surface of the tapered hole, and by inserting the tapered shaft portion into the tapered hole until the fastening attachment is engaged in both the helical flute formed on the outer periphery of the tapered shaft portion and the helical flute formed on the inner surface of the tapered hole and elastically pressed against the surfaces of both helical flutes, with the shoulder surface in close contact with the front end surface of the shank, and an outer peripheral surface portion of the tapered shaft portion in close contact with an inner surface portion of the tapered hole.

2. The cutting tool of claim 1, wherein the fastening attachment comprises a tapered helical coil having, in a free state, a winding pitch smaller than pitches with which the respective helical flutes are arranged, whereby the fastening attachment can be stretched and fitted in either one of the helical flute formed on the outer periphery of the tapered shaft portion and the helical flute formed on the inner surface of the tapered hole.

3. The cutting tool of claim 2, wherein the fastening attachment is structured such that with the fastening attachment stretched until the winding pitch thereof is equal to the pitches with which the respective helical flutes are arranged, the fastening attachment has a tapered angle substantially equal to tapered angles (α and α1) of the tapered shaft portion and the tapered hole, respectively.

4. The cutting tool of claim 1, wherein the fastening attachment is made of a material softer than a material forming cutting edges.

5. The cutting tool of claim 1, wherein the contact surface area between the outer peripheral surface of the tapered shaft portion and the inner surface of the tapered hole is 75% or over of the contact surface area if there were no helical flutes.

6. The cutting tool of claim 1, wherein the helical flute formed on the outer periphery of the tapered shaft portion and the helical flute formed on the inner surface of the tapered hole have helix angles, respectively, which are both 75° and over and less than 90°.
